(19) United States
(12) Patent Application Publication
(10) Pub. No.: US 2024/0420600 A1
(43) Pub. Date: Dec. 19, 2024

(54) ELECTRONIC DISPLAY DEVICE FOR DISPLAYING A MACHINE-READABLE CODE

(71) Applicant: VusionGroup GmbH, Fernitz-Mellach (AT)

(72) Inventors: Philipp HERRNEGGER, Fernitz-Mellach (AT); Peter GROISS, Laakirchen (AT)

(73) Assignee: VusionGroup GmbH, Fernitz-Mellach (AT)

(21) Appl. No.: 18/708,894

(22) PCT Filed: Dec. 29, 2021
(86) PCT No.: PCT/EP2021/087819

§ 371 Date: May 9, 2024

(51) Int. Cl. G09F 3/20; G06K 19/06

(52) U.S. Cl. CPC G09F 3/208; G06K 19/06009

(57) ABSTRACT

The invention relates to an electronic display device for displaying product and/or price information, said device being designed to display a machine-readable code and having a housing. The invention is characterized in that the electronic display device has a code carrier which can be moved relative to the housing and which has the machine-readable code.

### TECHNICAL FIELD

The invention relates to an electronic display device for displaying a machine-readable code.

### BACKGROUND

Today, in retail, ever more electronic display devices are being used, particularly electronic shelf labels, which are known by their English designation “Electronic Shelf Label”, ESL for short. In the case of large sales areas, thousands of such ESLs can thus be used. The ESLs comprise a screen, in order to display product and/or price information. These ESLs are in particular fastened on shelving units, for the most part by means of a shelf edge strip, or directly on the product.

In order to be able to manage such a high number of ESLs logistically, each ESL comprises a unique machine-readable code, with the aid of which the respective ESL is uniquely identifiable. Such machine-readable codes are for the most part realized as a barcode or QR code. This machine-readable code can be scanned by means of a corresponding code scanner and subsequently electronically/digitally processed. A code scanner of this type may for example be a stand-alone device or a mobile telephone having a corresponding application. This unique identification of the ESL enables the association between the ESL and a product and/or a position inside the sales area, which is stored in a database or in what is known as a planogram.

In the past, two variants have become established for displaying this machine-readable code.

In the case of the simplest, first variant, the machine-readable code is printed directly onto the housing of the ESL. This has been established as disadvantageous, however, because in this manner on the one hand the machine-readable code negatively influences the appearance of the ESL and the design possibilities of the housing of the ESL and because, in this manner, on the other hand the code is often not accessible and as a result cannot be scanned. This occurs for example if the machine-readable code is attached on a side wall or rear wall of the ESL and the ESL is placed close to other objects, so that the machine-readable code can only still be accessed with difficulty or is not at all accessible.

Because of these disadvantages, the second variant has become established, wherein the machine-readable code is displayed with the aid of the screen of the ESL. This is often not desired, however, and not at all possible in the case of a malfunction.

The increasing use of self-scan apps, that is to say applications for mobile telephones, using which potential customers can scan a code relating to a product in order to be able to obtain further information and/or to carry out a purchase, in many cases leads again and again to problems in both cases, because the machine-readable code relating to the electronic display device is positioned in the field of view of potential customers. This machine-readable code relates however to the electronic display device and not the product as such. This leads to a fault during the scanning process, so that potential customers possibly interpret the self-scan app as insufficiently mature and cancel their “digital” purchase.

The invention is therefore based on the object of providing an electronic display device, in which the previously explained problems are overcome.

### SUMMARY OF THE INVENTION

This object is achieved by an electronic display device for displaying product and/or price information according to claim 1. The subject matter of the invention is therefore an electronic display device for displaying product and/or price information, which is designed for displaying a machine-readable code and comprises a housing, characterized in that the electronic display device comprises a code carrier which is movable with respect to the housing and carries the machine-readable code.

The mobility of the code carrier makes the machine-readable code accessible even in the case of unfavourable placement of the display device. The code carrier which is movable with respect to the housing makes it possible for an employee to position or orientate the code carrier such that the code can readily be scanned with the aid of the code scanner.

As the machine-readable code is always available on the code carrier, this can also be scanned and processed further at any time. Thus, a defective electronic display device can for example be easily identified and exchanged, specifically even if the screen is defective or has failed.

Due to these measures, both temporal and local hurdles are therefore overcome during scanning of the machine-readable code, because the machine-readable code can be detected at any time, even in the case of a placement of the electronic display devices, which is problematic for the scanning, or in the case of little available space.

Further particularly advantageous embodiments and developments of the invention result from the dependent claims and also the following description.

The electronic display device preferably comprises the aforementioned screen for displaying the product and/or price information, which screen is located on the front side of the electronic display device.

The electronic display device is positioned on an object, wherein a rear side of the electronic display device is located in a manner orientated towards the object. This positioning can for example take place by means suspension, adhesive bonding, clamping on, etc.

Preferably, in addition to the machine-readable code, the code carrier comprises at least one further code, particularly a human-readable code. This further code can for example be a symbol, a logo, a text or similar. Although the machine-readable code can be optically detected and perceived by a human, the human-readable code differs from the machine-readable code in that a human can interpret the information content of the human-readable code directly, that is to say without further, particularly technical, aids.

The attachment of the further code on the code carrier makes it possible to redeploy information, which would otherwise have to be displayed on the screen of the electronic display device, such as the company logo for example, on the code carrier, so that display area on the screen, which can be used for the display of changeable image contents, becomes or remains free. Therefore, display area of the screen for displaying changeable image contents or video contents is generated or kept free by redeploying static image contents on the code carrier. Therefore, the code carrier which carries the further code is a technical means which contributes to generating an improved information reproduction of the electronic display unit or which is used for an improved information reproduction.

In order to ensure a particularly large freedom of movement of the code carrier, which simplifies the scanning process, it has proven advantageous that the code carrier protrudes from the housing.

The code carrier may for example comprise a hinge or be realized in a hinge-like manner or be realized as a hinge, which comprises a tab that carries the machine-readable code, and a spindle, formed as a pin or stud, about which the tab can be pivoted.

It has been established to be particularly advantageous if the code carrier is formed in a pliable manner at least in some areas, particularly completely. In contrast to the aforementioned hinge, a code carrier of this type can be produced in a compact and at the same time simple and cost-effective manner. A code carrier that is pliable at least in some areas can for example be realized in that a pliable material, such as for example a substance, a rubber or at least one cord connects a code-carrier body, such as for example a plastic plate or a sheet metal plate that carries the machine-readable code, to the housing of the electric display device. Therefore, a code carrier can be provided, which provides the mobility without complex joints.

In a completely pliable code carrier, it is possible to dispense with the code-carrier body and the code carrier can be printed directly on its pliable material. As a result, a more simply and cost-effectively producible code carrier is created, which can preferably be realized in one piece.

According to one aspect of the invention, the code carrier can be elastically deformable at least in some areas (in places).

In particular, the code carrier has a satisfactory restoring force as a consequence of an elastic deformation, in order to return to its initial orientation independently after taking away the force causing the deformation. This initial orientation, which is free from external forces, is preferably substantially parallel to the front side of the electronic display device or parallel to the screen of the electronic display device.

For this, elastic materials can be incorporated into the code carrier, for example interwoven. For this, the code carrier can also comprise its own elastic layers which provide the elastic deformability.

Also, the code carrier can be realized with an advantageous geometric arrangement or design, which benefits the springing back or resetting, as is explained further in the following.

The code carrier can be designed to be separable from the housing of the electronic display device and therefore easily replaceable for example. It is however particularly advantageous if the code carrier, particularly in the assembled state of the housing of the electronic display device, is permanently connected to the housing. As a result, it is ensured that the machine-readable code which identifies the electronic display device is in any case attached on the correct electronic display device.

This may be important for example in the course of maintenance and/or repair processes, if the display device has to be dismantled or opened in some areas. Therefore, in the case of a recent assembly, that is to say in the case of reassembly of the electronic display device, otherwise potentially possible confusions with other code carriers can be excluded. Such reassemblies may for example come about if the batteries of the electronic display device are replaced systematically in a business. For those parts which are not permanently connected to the housing, as for example in the case of battery covers, it may be that these are exchanged between the electronic display devices without this standing out. If the battery cover is used as code carrier, the confusion and incorrect assignment of the code carriers takes place precisely in this maintenance process.

Therefore, the fact that the code carrier is permanently connected to the housing contributes definitively to the reliable identification of the electronic display device. Furthermore, a rapid systematic maintenance (or a rapid systematic battery exchange) of the electronic display devices is therefore possible, because no additional attention must be placed on the association of the individual components of the display device.

Furthermore, this measure ensures that the code carrier cannot consciously or unconsciously be removed from the housing of the electronic display device.

For the permanent connection, the code carrier can be connected to the housing in a materially connected manner. Thus, the code carrier can for example be adhesively bonded to the housing or the housing can be welded or moulded around the code carrier. To realize a code carrier which, in the assembled state of the housing of the electronic display device, is permanently connected to the housing, the code carrier can also be fixed between the housing shells when the housing shells are assembled.

Preferably, the housing is structured in at least one front housing shell and one rear housing shell and the code carrier is inserted between the front and a rear housing shell.

The front housing shell is therefore located on the front side or forms the front side of the electronic display device and the rear housing shell is located on the rear side or forms the rear side of the electronic display device. The front housing shell in this configuration usually carries the screen or encloses it in a frame-like manner.

The housing can of course also be subdivided into further housing parts and can for example also comprise a side wall. Also in this case, the code carrier is inserted between adjacent housing parts such that it protrudes laterally from the housing. In this configuration, it is therefore also inserted between a front and a rear housing shell when considered spatially, wherein it is held between these two housing shells, possibly with the aid of one or more further housing parts.

This measure enables simple production and in particular simple assembly of the electronic display device, because the code carrier is inserted simply between two housing shells and is held there by the assembly of the housing shells. Of course, the code carrier can also additionally be secured, for example adhesively bonded, screwed on or else clamped in, particularly inside the housing shells. Also, with this additional securing, the electronic display device can be produced or assembled easily and permanently fix the code carrier.

It has been established to be particularly advantageous that the housing carries the screen on its front side and the machine-readable code is applied on the side of the code carrier which faces away from the front side. As a result, the machine-readable code is removed from the field of view of potential customers who are observing the electronic display device and the machine-readable code at the same time furthermore remains easily scannable.

The machine-readable code is therefore preferably directed or orientated towards the rear side of the electronic display device.

The further, in particular human-readable, code can be placed on the side of the code carrier which faces towards the front side, and thus occupy the majority of or the entire area of the code carrier which is visible when viewed from the front.

Often, in the case of the product and/or price information, which the electronic display device displays on its screen, in addition to the aforementioned machine-readable code which identifies the display device, a further machine-readable code relating to the product, namely a barcode, a QR code or similar, is also displayed, which allows potential customers to query further information about the product with the aid of their e.g. mobile telephone if they capture, that is to say scan, this barcode or QR code using the camera of the mobile telephone. In the past, this has often hindered the scanning process for employees who want to scan the machine-readable code which relates to or identifies the ESL, because the code scanner possibly scans the incorrect code, namely the code relating to the product, as soon as it is orientated or moved towards the display device. This may lead to the display of a scanning error on the code scanner, which hinders the workflow. Scanning processes which are carried out incorrectly as valid can lead to errors in the database or the planogram, which are difficult to identify and must be remedied manually in a labour-intensive manner.

As the machine-readable code relating to the identification of the electronic display device can still only be applied on the side of the code carrier which faces away from the front side, the scanning process to be carried out by the employee can be carried out considerably more precisely, because the employee must first make this machine-readable code accessible for the scanning process. To this end, it is necessary that he/she contacts the code carrier with one finger and folds down in order to make the machine-readable code accessible. The code carrier which is indeed positioned on the side of the display device and protrudes from the same substantially parallel to the front of the screen, is folded towards the side wall in the process and can there be orientated substantially parallel to the side wall of the display device, so that the machine-readable code also becomes accessible from this side. In this orientation of the code carrier, the machine-readable code is then predominantly captured from the side with the aid of the code scanner, so that no further machine-readable code relating to the product is usually located in the surroundings of the machine-readable code. Defective capturing is therefore excluded already due to the positioning or the orientation which the code scanner must assume. This makes it possible for the employee to capture a multiplicity of machine-readable codes of the electronic display devices in one business fast and efficiently, specifically without struggling with defective captures and associated error notifications.

According to a further aspect of the invention, the code carrier is formed in an extensive manner at least in some areas, preferably completely. This extensive design on the one hand allows a simple and cost-effective production. Furthermore, it allows a particularly simple attachment of the code and good mechanical properties, as is explained in the following.

It has furthermore proven advantageous that the code carrier consists of textile at least in some areas, preferably completely. On the one hand, this allows a cost-effective production. On the other hand, the mechanical properties of the code carrier, particularly relating to the elasticity or capacity for generating restoring forces and the flexural rigidity or the pliability or simple mobility can be provided optimally.

The textile comprises textile fibres which mostly form the main constituent of the textile. Textile fibres is understood to mean a linear entity, wherein the longitudinal extent or length is substantially larger than the diameter of the linear entity. Furthermore, textile fibres have a satisfactory longitudinal extent or length and also flexibility and pliability as a prerequisite for their workability in a textile manufacturing method, particularly for the workability during spinning. Textile fibres can be natural fibres or synthetic fibres, wherein a textile can also comprise a combination of natural fibres and synthetic fibres. Flock fibres, rubber fibres and/or metal fibres can also be used as textile fibres for example, wherein these fibres are formed in such a manner that they can be processed in a textile-like manner.

The textile can also be realized linearly or as a three-dimensional entity. The textile is preferably formed in a planiform manner.

In addition to textile, further materials, such as leather, artificial leather, rubber, metal or similar natural or synthetic materials can also be used. In general, most of the materials that can be used for the textile can also be used in a different form from the textile fibres, for example in the manner of a film as e.g. a plastic film. Also, the materials can be combined.

As explained, it is generally advantageous if the code carrier is formed in an extensive manner, which can in any case readily be realized using the aforementioned materials.

The code carrier which is formed in an extensive manner can easily be printed with the machine-readable code and possibly with the further human-readable code. Thus one code can be printed on one side of the code carrier, whilst the other, further code, particularly the human-readable code, is printed on the other side. During production, a code carrier of this type, which is printed on both sides must therefore either be turned in order to be printed in two steps or be printed from two sides by two printing units without being turned in-between.

According to a further embodiment, the code carrier can be formed in a loop-like manner. This enables a simplified production method, as is described in the following.

The loop-like design of the code carrier offers the advantage that as a result, the resilient effect of the code carrier is improved. As a result, the elastic deformability of the code carrier can be accomplished in a simple manner. Here, this is therefore an advantageous geometric arrangement or design of the code carrier, which in combination with the corresponding material choice provides an optimum elastic deformability.

In the case of the placement of more than only one code, that is to say more than just the machine-readable code, on the code carrier, these two codes only have to be applied on one side of the flat code carrier. Subsequently, the code carrier is folded or shaped to form its loop shape, as a result of which the codes assume their desired orientation or alignment on the code carrier on the outer side of the loop, that is to say along the curved shape of the loop.

The code carrier loop obtained in this manner can be connected to the rest of the electronic display device as already explained previously.

As a result, just like in the case of a code carrier which is printed on both sides and formed not in a loop-like, but rather only in a planiform manner, one code, for example the human-readable code, can be placed in such a manner that it is directed to the front side of the electronic display device, whilst the other code, for example the machine-readable code, is directed to the rear side of the electronic display device.

The respective code can be applied on the code carrier after the attachment of the code carrier. It has however been established as advantageous in terms of production technology that the machine-readable code (as well as the possible other code) is applied onto the code carrier before the code carrier is integrated into the electronic display device.

These and further aspects of the invention emerge due to the figures discussed below.

### BRIEF DESCRIPTION OF THE FIGURES

The invention is explained once more in detail in the following with reference to the attached figures on the basis of exemplary embodiments, to which the invention is not restricted, however. In the various figures, identical components are provided with identical reference numbers. In the figures, in a schematic manner:

FIG. 1 shows an electronic display device having a code carrier;

FIG. 2 shows the electronic display device in a side view;

FIG. 3 shows a view of the rear side of the electronic display device;

FIG. 4 shows the electronic display device according to FIG. 3, fastened on a product;

FIG. 5A-5D shows various exemplary embodiments of the code carrier;

FIG. 6 shows the electronic display device having an adhesive layer;

FIG. 7 shows the electronic display device according to FIG. 6, which is adhesively bonded to a product with the aid of the adhesive layer;

FIG. 8 shows the electronic display device fastened on a shelving unit;

FIG. 9 shows a further view of the electronic display device according to FIG. 8.

### DESCRIPTION OF THE EXEMPLARY EMBODIMENTS

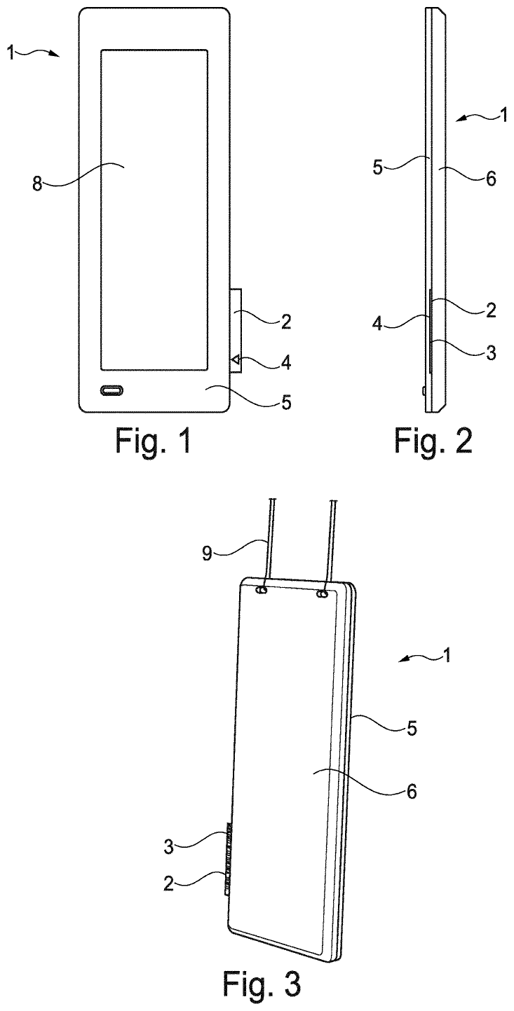

FIGS. 1 to 3 show an electronic display device 1 which comprises a movable code carrier 2, which is manufactured in an extensive manner from textile. The display device 1 comprises a housing which is subdivided into a front housing shell 5 and a rear housing shell 6. The front housing shell 5 comprises a recess in which a screen 8 is located, which is formed as an electrophoretic e-paper screen or reflective display. The screen 8 is connected to electronics in the interior of the housing of the electronic display device 1 and provided to display product and/or price information which is transmitted by radio to the display device 1.

The code carrier 2 protrudes laterally from the housing of the electric display device 1 in a flat manner. The code carrier 2 is sited and fixed between the two housing shells 5 and 6 and aligned in the same in this initial orientation that is illustrated here, parallel to the front side of the electronic display device 1, particularly to the front of the screen 8. The code carrier 2 comprises a machine-readable code 3, which is realized as a barcode and is applied on the side of the code carrier 2 which is directed to the rear housing shell 6. Furthermore, the code carrier 2 comprises a machine-readable code 4 which is applied on the side of the code carrier 2 which is directed to the front housing shell 5. The human-readable code 4 is illustrated here as a triangle which is used as a stand-in for any desired logo or symbol, for example the brand logo of the company that uses the electronic display device 1. Of course, a text can be applied here in the same way.

The electronic display device 1 is designed to be applied to a product 12 and/or to a shelving unit 13 in various ways, which is discussed in the following in the context of the code carrier 2 in particular.

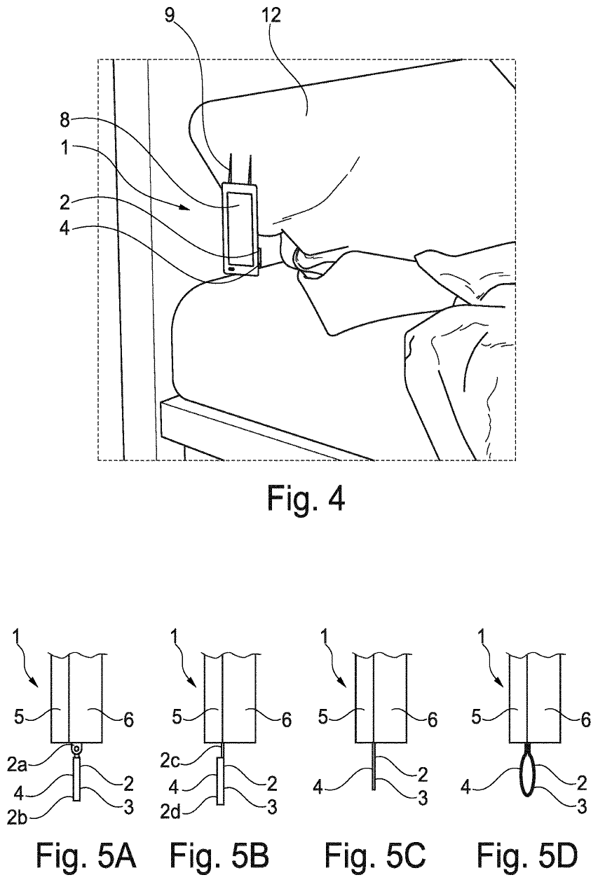

In FIG. 3, an exemplary embodiment is illustrated, wherein the electronic display device 1 is designed for application in a suspended manner. For this, the electronic display device 1 comprises openings in the housing and also cords 9, wherein the cords 9 are threaded through the openings in the housing of the electronic display device 1. The cords 9 can furthermore be fastened on the product 12 (or alternatively also on a shelving unit 13), as is shown in FIG. 4. The code carrier 2 in this exemplary embodiment is manufactured from an extensive textile.

FIG. 4 shows the electronic display device 1 that is fastened on the product 12. The product 12 here is a pillow that is presented on a bed that is appropriate for it and has been placed on the bed in such a manner that it appears as appealing as possible for potential customers. Potential customers who examine the product 12 and the electronic display device 1 can immediately see the content of the screen 8 and the human-readable code 4 without being distracted by the machine-readable code 3. By contrast, an employee who would like to scan the machine-readable code by means of a code scanner can easily, by means of the action of force of one of their fingers on the code carrier 2, tilt the code carrier forwards with respect to the housing in the direction of the screen 8 and thus make the machine-readable code 3 accessible from the right side of the display device 1. After that, the employee can readily scan the machine-readable code without having to manipulate the product 12 or even the display device 1 with regards to position or orientation. In this suspended configuration, the described process of course also benefits the fundamental mobility of the entire display device 1 with respect to the pillow. The employee can therefore very easily scan the machine-readable code 3 and proceed directly to the next product, without the product 12 having to be repositioned again after scanning. Therefore, the most appealing possible appearance of the product 12 for potential customers is retained and does not have to be reproduced after the scanning, as may often be the case in the case of known display devices without a code carrier 2. This advantage becomes noticeable in particular in the case of a display device that is fastened in a fixed manner on a different structure, such as for example a shelving unit or a product.

FIGS. 5A to 5D show different exemplary embodiments of the movable code carrier 2. In FIGS. 5B to 5D, the code carrier 2 is clamped in some areas between the front housing shell 5 and the rear housing shell 6. Therefore, the housing shells 5 and 6 have an accommodating region in the region in which they are connected, which accommodating region is adapted to the thickness of the code carrier 2 for accommodating the code carrier 2. In addition to this preferred embodiment, however, different placement options for the code carrier 2 are also possible. Thus, the code carrier 2 can be inserted in an opening of the front housing shell 5 or the rear housing shell 6 or be fastened, for example adhesively bonded, on one of the housing shells 5 or 6.

In FIG. 5A, the code carrier is fastened directly in the region in which the two housing shells 5 and 6 are connected. The code carrier 2 is realized as a hinge in this exemplary embodiment. For this, the code carrier comprises a code-carrier body 2b which acts as a tab of the hinge and is connected to a spindle 2A, which is realized as a stud, wherein the spindle enables the mobility with respect to the housing. Here, the housing of the electronic display device 1 or the rear housing shell 6 acts as second tab of the hinge. The code carrier 2 also carries the machine-readable code 3 and the human-readable code 4 in this example. The code-carrier body 2b can for example have a three-dimensional logo as human-readable code 4. A three-dimensional logo can be introduced directly into the code-carrier body 2b during the production method, for example in an injection moulding method. A three-dimensional logo can however also be introduced into the code-carrier body 2b subsequently by means of milling. However, both codes 3 and 4 can also easily be printed or engraved or laser engraved on the code-carrier body 2b.

FIG. 5B shows a further exemplary embodiment of the code carrier 2. Here also, the code carrier 2 comprises a code-carrier body 2d. Here, this is connected to a code-carrier connecting piece 2c which connects the code-carrier body 2d to the housing of the electronic display device 1. The code-carrier connecting piece 2c here is an extensive textile which provides the mobility with respect to the housing. In this exemplary embodiment, the code-carrier body 2d can also have a three-dimensional logo as human-readable code 4 in addition to the machine-readable code 3. Due to the code-carrier connecting piece 2c, the code carrier 2, particularly the code-carrier body 2d, is movable with respect to the housing. In contrast to the design as a hinge (see FIG. 5A), the production and in particular the assembly of this display device is substantially easier however. Also, a code carrier 2 can thus be cost-effectively produced with a three-dimensional logo or similar and integrated into the display device.

FIG. 5C shows a code carrier 2 which consists of an extensive textile. Textile made from polyester fibres can for example be used as textile for this, because these fibres can be washed and processed well. The code carrier 2 made from textile is dimensioned such here that on the one hand it is sufficiently pliable to allow simple movement of the code carrier relative to the housing of the electronic display device. At the same time, the code carrier 2 is dimensioned in such a manner that it is elastically deformable during this movement, that is to say that a restoring force is set, which moves the code carrier 2 back to the initial orientation when the load which led to the movement stops.

FIG. 5D shows a further exemplary embodiment, wherein the code carrier 2 is manufactured from textile. Here, the code carrier 2 is formed in a loop-like manner. This is associated with the advantage that the previously mentioned mechanical properties can be improved or set more easily. Due to the loop-like form, when deformed, the code carrier 2 has a strong desire to assume its original shape again as a consequence of internal tensions. As can be seen from the illustration, both codes, that is to say the machine-readable code 3 and the human-readable code 4, are applied on the outwardly directed surface of the loop-like code carrier 2. In spite of this, the human-readable code 4 is directed to the front housing shell 5, whilst the human-readable code 3 is directed to the rear housing shell 6, because they are located at different positions along the loop. The code carrier can therefore be manufactured easily, because only one side has to be printed on and the code carrier is subsequently brought into its loop-like shape, which is why each respective code 3 and 4 assumes its provided orientation or is located on its provided side of the electronic display device 1.

The embodiments according to FIGS. 5C and 5D differ from the embodiments according to FIGS. 5A and 5B in that the code carriers 2 are relatively easily deformable over the whole area, whereas the code carriers 2 according to the embodiments 5A and 5B are by contrast formed in a relatively stiff manner at least in the region of the code-carrier body 2b and 2d.

FIG. 6 shows an exemplary embodiment, wherein the electronic display device 1 is formed to be fastened on a product 12 (or a shelving unit 13) by means of an adhesive joint. For this, the electronic display device 1 comprises an adhesive layer 10 which is connected to the rear housing shell 6. The adhesive layer 10 illustrated in FIG. 6 is still covered with a protective layer here however, which must first be removed before the adhesive effect of the adhesive layer 10 can be used.

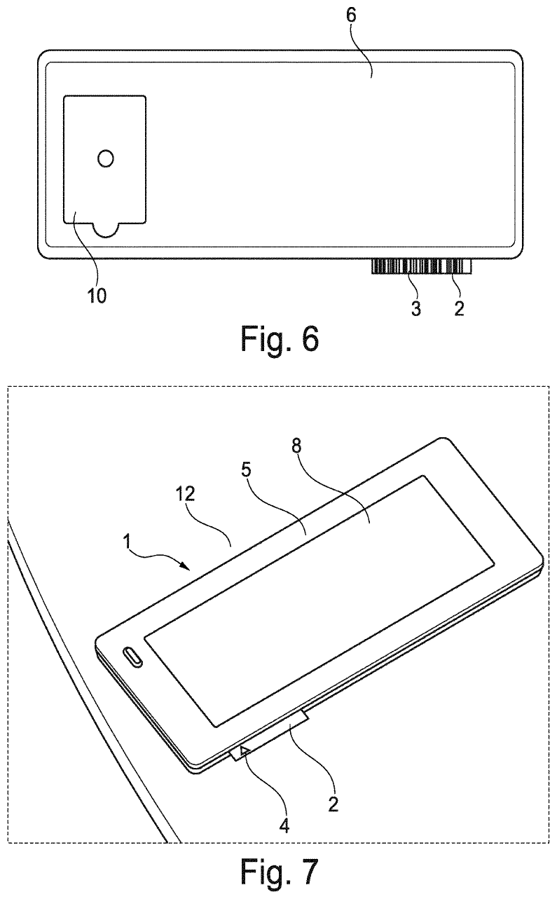

In FIG. 7, the electronic display device 1 is adhesively bonded to a product 12 by means of adhesive layer 10. This product 12 is a table, wherein the electronic display device 1 was adhesively bonded to the tabletop thereof with the aid of the adhesive layer 10. A potential customer can thus immediately detect the screen 8, which displays the product and/or price information, when looking at the product and the human-readable code 4, that is to say the logo for example, without being distracted by the machine-readable code 3. By contrast, an employee who would like to scan the machine-readable code 3 can move or fold down the code carrier 2 to the housing or to the table relatively easily and therefore make the machine-readable code 3 accessible for the scanning from the lateral direction (that is to say essentially along the tabletop plane) and as a consequence scan the machine-readable code 3 by means of a code scanner.

In order to provide an electronic display device 1 without code carrier 2, which presents the content of the screen 8 and the human-readable code 4 without the machine-readable code 3, the machine-readable code 3 would have to be applied on the rear side, that is to say the rear housing shell 6 of the electronic display device 1. The code 3 would therefore only be scannable if the electronic display device 1 were separated from the product 12. This is connected with an enormous outlay and in the case of repeated repetition possibly leads to damage of the product and/or the electronic display device 1, particularly the adhesive layer 10. The use of the movable code carrier 2 prevents precisely these problems and at the same time ensures the efficiency and the cost effectiveness of the scanning process.

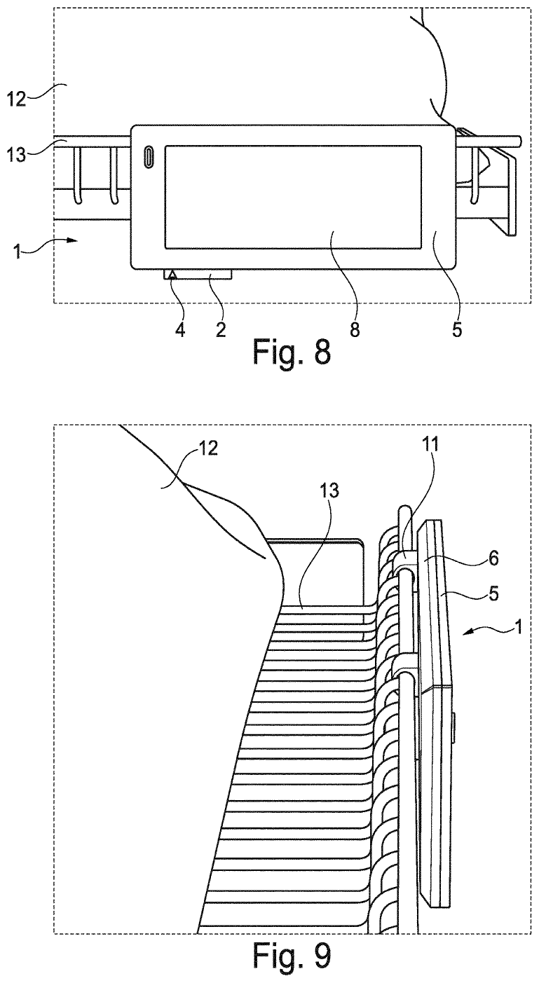

FIG. 8 and FIG. 9 show an exemplary embodiment of the electronic display device 1 which is formed for attachment to a shelving unit 13. For this, the electronic display device 1 comprises two fastening clamps 11 which clamp on a bar which forms the front end of the shelf of the shelving unit 13. A pillow-like product 12 is located in the shelving unit 13. As explained previously, the code carrier 2 here also enables an efficient and cost-effective scanning of the machine-readable code 3 which, outside of the scanning process, is positioned in the shelving unit hidden from the sights of potential customers, orientated rearwards. Also, in this configuration, the code carrier 2 can very easily be folded forwards relatively to the housing or to the shelving unit 13 and the machine-readable code 3 can therefore readily be scanned from below.

It is noted once more that particularly with the increase of self-scan apps, in which potential customers scan the electronic displays 1 in order to obtain additional information about a product or to register a purchase, positioning of the machine-readable code 3 relating to the identification of the electronic display device 1 outside of the viewing area of the potential customer is of definite relevance. Were a potential customer to scan the machine-readable code 3 which relates to identification of the electronic display 1 and not the product 12 as such, this may as mentioned lead to a fault, which deters the potential customer, damage the image of the company which offers this self-scan app and/or commit employees, because these employees would have to explain the scanning fault or would have to be helpful in avoiding the scanning fault. The movable code carrier 2 ensures that this undesired problem situation does not occur.

Finally, it is once more noted that the figures previously described in detail are only concerned with exemplary embodiments, which can be modified in many different ways by a person skilled in the art, without departing from the scope of the invention. For the sake of completeness, it is also noted that the use of the indefinite article “a” or “an” does not mean that the relevant features cannot also be present multiple times.

1. An electronic display device (1) for displaying product and/or price information,
which is designed for displaying a machine-readable code (3) and comprises a housing (5, 6),
characterized in that
the electronic display device (1) comprises a code carrier (2) which is movable with respect to the housing (5, 6) and carries the machine-readable code (3).

2. The electronic display device (1) according to claim 1, characterized in that the code carrier (2) protrudes from the housing.

3. The electronic display device (1) according to claim 1, characterized in that the code carrier (2) is formed in a pliable manner at least in some areas, particularly completely.

4. The electronic display device (1) according to claim 1, characterized in that the code carrier (2) is elastically deformable at least in some areas.

5. The electronic display device (1) according to claim 1, characterized in that the code carrier (2) is permanently connected to the housing (5, 6).

6. The electronic display device (1) according to claim 1, characterized in that the housing (5, 6) is structured in at least one front housing shell (5) and one rear housing shell (6) and in that the code carrier (2) is inserted between the front and a rear housing shell (5, 6).

7. The electronic display device (1) according to claim 1, characterized in that the housing (5, 6) carries a screen (8) on its front side and the machine-readable code (3) is applied on the side of the code carrier (2) which faces away from the front side.

8. The electronic display device (1) according to claim 1, characterized in that the code carrier (2) is formed in an extensive manner at least in some areas, preferably completely.

9. The electronic display device (1) according to claim 1, characterized in that the code carrier (2) consists of textile at least in some areas, preferably completely.

10. The electronic display device (1) according to claim 1, characterized in that the code carrier (2) is formed in a loop-like manner.
